(19) United States
(12) Patent Application Publication
(10) Pub. No.: US 2013/0304489 A1
(43) Pub. Date: Nov. 14, 2013

(54) Remote Monitoring And Diagnostics Of Medical Devices

(71) Applicant: LANTRONIX, INC., Irvine, CA (US)

(72) Inventor: Daryl R. Miller, Rancho Santa Margarita, CA (US)

(73) Assignee: Lantronix, Inc., Irvine, CA (US)

(21) Appl. No.: 13/890,089

(22) Filed: May 8, 2013

Related U.S. Application Data
(60) Provisional application No. 61/644,123, filed on May 8, 2012.

(51) Int. Cl. G06Q 10/00; G06Q 50/22

(52) U.S. Cl. CPC G06Q 10/20; G06Q 50/22
USPC 705/2

(57) ABSTRACT

A system or method to authenticate with a medical device, identify the device, and subsequently communicate with any existing or newly added medical devices is presented. The system also is capable of gathering, analyzing and evaluating information from medical devices connected to a health care network. The present disclose leverages embedded device servers to transmit information from medical devices to a hospital information system for further evaluation, or action when required. A module or embedded device may be associated with any specific medical device such that communication between the device and the hospital system may take place whereby information may be received by the hospital information system to evaluate medical device functionality and other important characteristics as desired by the administrator.

This application claims the benefit of priority to U.S. provisional application 61/644,123 filed May 8, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention relates to medical device technologies.

### BACKGROUND

The following description includes information that may be useful in understanding the present invention. It is not an admission that any of the information provided herein is prior art or relevant to the presently claimed invention, or that any publication specifically or implicitly referenced is prior art.

In many cases an embedded system is deployed in the field and forgotten. Meanwhile, technology evolves and changes around the deployed system. Older deployed systems have serial interfaces to gain access to the device and information it contains. As the Internet has become prevalent, users wish to access their devices without having to go personally to the device and plug in a computer to download data. Consequently, a demand arose to Internet enabling the older devices by creating products that have a serial port on one end and an Ethernet port on the other end, which can accept the data from the device and send the data over the Internet. This is advantageous because it eliminates the need to do costly replacements for the device.

Embedded systems today can be connected to computer networks (for example, the Internet) and to legacy devices. These embedded systems allow connectivity with various equipment, legacy as well as state of the art. For example, an embedded system allows network/Internet connectivity to vending machines, refrigerators, utility meters, HVAC systems, and home entertainment systems.

Now that the Internet has been around for awhile, there are devices that are Internet enabled and are being used in the field. Just as the serial devices had limited resources and could not be upgraded easily, the older Internet devices also have limited resources and cannot be upgraded cost effectively. The Internet has grown and with it security concerns have grown tremendously. There is now a need to upgrade Internet enabled embedded systems to include security capabilities such as encryption or authentication. However, the firmware on the devices cannot be upgraded because the processors in these embedded systems are underpowered and there are insufficient resources to run new and complex encryption or authentication software. Therefore, there is a need for a low cost method for converting data from a device to a secure data stream.

The number of network-connected devices has grown dramatically over the last decade. Such growth is expected to continue far into the future, causing enormous problems of integration for consumers, companies, and governments. One significant problem is the inclusion of many legacy devices that were never intended to be connected to a network. For instance, gaining information regarding bulb life on a projector can reduce down time by allowing a manager to replace the bulb before it burns out. But electrical systems that operate light bulbs are generally not designed to be networked.

Another problem is the ever-growing number of network enabled devices that have inadequate monitoring and control capabilities. These problems are pervasive, involving all manner of equipment from fax machines, printers, copiers and other office equipment, to specialized devices found in manufacturing plants, home appliances, handheld electronics such as cameras, audio/video players and medical devices that have network capability but are not part of an integrated network. This problem is particularly acute for the administrators, who often find themselves spending a great deal of money and time bridging heterogeneous management systems. Most of these devices do not contain state information and are even more difficult to manage. A more homogeneous management environment can save time and money, but numerous vendors have many valid business and technical reasons for avoiding homogeneous management systems.

Device management functionality comes in many different forms depending on the administrator's needs and the capabilities of the target device. Common management functions include monitoring the device's critical information, taking an inventory of the device's sub-systems, logging interesting events that take place, sending alerts to an administrator, recovering the device if the power fails, ensuring the data is secure, asset tracking, or reporting information to an administrator. Administrators also employ more advanced management functions including scripting or programming, aggregating device data from multiple devices, diagnostics, taking action based on the device data content, trending device data, reporting information in a final format including a spreadsheet or graph, or translating from one management format to another. A major area of management functionality includes securing the device through providing confidentiality of data, data integrity, administrator authentication, device authentication, risk mitigation, countermeasures, or protection against hostile environments and threats.

A need also exists for mining of medical device data from devices in health care facilities which are connected to a health care network. Additionally, a need exists for a system or method for utilizing an embedded device server to mine information and data from medical devices connected to a health care facility network.

Still further, various medical devices surrounding a patient's bed operate independently of each other and include non-standard wires, tubes, and interfaces. One problem is lack of integration between the medical devices and in some cases the inability of the device to communicate with other medical devices or hospital administrative personnel. For example, some medical devices generate information in a proprietary format, which is not compatible with other medical devices from different vendors. As a result of this lack of integration, health facility IT/IS administrators must pay greater attention to control and monitor many medical devices individually, requiring more personnel to maintain and set up medical devices, more time to review the data, from the device and more time spent on diagnostics of the medical devices. Additionally, there is little to no integration between the plurality of medical devices and little ability to retrofit legacy devices to be able to communicate with other devices.

Therefore, a need exists in the medical community to have integrated medical devices that may allow device management and interface between a plurality of medical devices. Additionally, a need exists for a graphical tool system to allow management and information retention of what medical devices may be connected to an integrated medical network. There is also a need for a system or method for remotely monitoring medical devices either from inside or outside a health care facility. Moreover, a need exists for a system and a method for remotely monitoring and diagnosing information from medical devices and using a device server to communicate and receive information from remote medical devices located within a health care setting.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a medical facility network is able to interact with medical devices over a network. One aspect of the inventive subject matter includes a system that provides network communications among medical devices, hospital information systems, or other medical facility networks. Contemplated systems include a medical device lacking a configuration or capability to connect with a target medical facility network (e.g., electronic medical record system, patient database, etc.). In some embodiments, the medical device can incorporate an embedded device where the embedded device is configured to connect a target medical facility network. Further, the system can include a device server that couples with the medical device, possibly via the embedded device where the device server aids in communicating with the medical device or provides additional services that are compatible with a health information system. The device server can be configured to locate the medical device (e.g., geolocation via GPS, radio frequency ranging, access point triangulation, etc.). Further the device server can retrieve information from the medical device, possibly via the embedded device, then provide the information to a hospital information system via the medical facility network.

Another aspect of the inventive subject matter includes a system that integrates many medical devices into a medical facility network. Such a system also includes a medical device that can couple with the medical facility network, possibly via a serial port, Ethernet port, wireless connection, or other communication channel. Further, the system includes a server coupled with the medical facility network and capable of exchanging information with the medical device. Contemplated servers are configured to send an initialization signal to the medical device where the initialization signal causes the medical device to take action. For example, upon receiving the initialization signal the medical device will be receptive to further communications with the server. Thus, the server can continue to automatically initialize the medical device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of an integrated medical device network system.

### DETAILED DESCRIPTION

It should be noted that while the following description is drawn to a computer/server based medical systems, various alternative configurations are also deemed suitable and may employ various computing devices including servers, interfaces, systems, databases, agents, peers, engines, controllers, or other types of computing devices operating individually or collectively. One should appreciate that such terms are deemed to represent computing devices comprising a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, within the context of networked device the terms “coupled to” and “coupled with” are also used euphemistically to mean “communicatively coupled with” over a network, possibly through one or more intermediary devices.

The presented inventive subject matter includes embodiments that employ a system or method to authenticate with a medical device, identify the device, and subsequently communicate with any existing or newly added medical devices. The system also is capable of gathering, analyzing and evaluating information from medical devices connected to a health care network. Some embodiments utilize one or more embedded device servers to transmit information from the medical device to a hospital information system for further evaluation, or action when required. A module or embedded device may be associated with any specific medical device such that communication between the device and the hospital system may take place whereby information may be received by the hospital information system to evaluate medical device functionality and other important characteristics as desired by the administrator. Moreover, the some embodiments also employ a system whereby the system is able to communicate and diagnoses problems with a medical device and allows complete integration of information from the medical device with a hospital information system as desired.

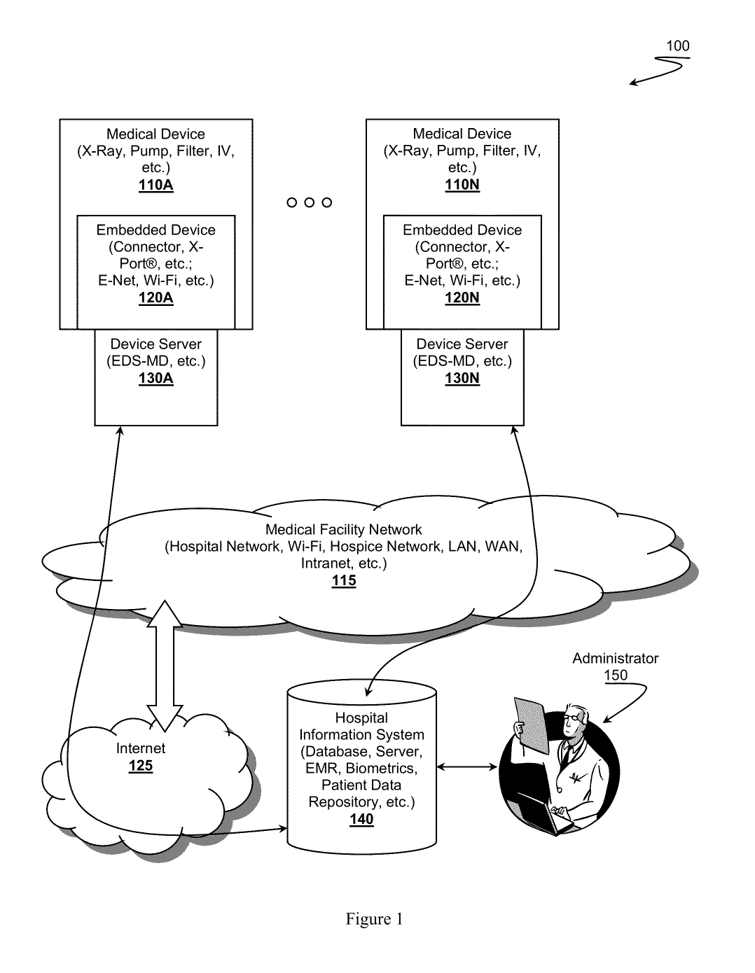

In FIG. 1, system 100 can be considered to represent a medical facility network ecosystem where medical devices 110A through 110A, collectively referred to as medical devices 110, can interact with a facility's information system as represented by hospital information system 140. System 100 also includes medical facility network 115 representing the communication infrastructure among the elements system 100. One or more of system administrator 150 can access information from medical devices 110 via the medical facility network or the hospital information system 140. Although the following disclosure is presented with respect to medical devices, it is also contemplated that the inventive techniques can be applied to alternative markets including gaming systems, office equipment networks, or other networks of devices.

In the example shown, medical devices 110 can take on many different forms. Example medical devices include patient monitoring devices, mobile EKG units, glucose analyzers, blood analyzers, infusion pumps, ventilators, incubators, or other devices. Typically, medical devices 110 lack an ability to connect or couple with medical facility network 115 or lack an ability to integrated with a health or hospital information system 140. For example, medical devices 110 might lack a serial port, Ethernet port, wireless radio (e.g., 802.11, WiGIG, etc.), or other connector that is compatible with medical facility network 115. In such embodiments, the manufacturer of such devices can incorporate or integrate an embedded connector, represented by embedded devices 120A through 120N collectively referred to as embedded devices 120, into an existing design. Examples of embedded devices 120 include the Lantronix® X-Port®, MatchPort®, Micro, PremierWave®, WiPort, or other types of embeddable devices capable of interfacing to medical facility network 115. In some embodiments, embedded devices 120 include an administrator interface (e.g., Telnet, HTTP server, API, etc.) through which administrator 150 can gain access to embedded device 120 for configuration or to gain access to corresponding medical device 110.

Further, system 100 also includes device servers 130A through 130N, collectively referred to as device servers 130, are also able to couple with medical devices 110, possibly via embedded devices 120. There are multiple possible variations on the configurations presented in FIG. 1. One variation could include device server 130A coupling directly with embedded device 120A where device server 130A provides connectivity not only to medical facility network 115 but also to hospital information system 140. Another variation could include device server 130A offering a different modality of connection to medical facility network 115 (e.g., wireless) than that of embedded device 120A (e.g., wired). Regardless of the type or nature of the configuration, device servers 130 are configured to fulfill multiple roles or responsibilities within the illustrated ecosystem.

Device servers 130 can be configured to locate medical devices 110 within the environment. In some embodiments, device servers 130 can include a location module capable of determining the location of the individual device servers 130, where the location can then be used by administrator 150 to determine the location of the corresponding medical device 110. Example location modules can include a cellular radio capable of triangulating a location based on relative cellular signal strengths, a wireless radio (e.g., 802.11, Bluetooth, etc.) capable of triangulating a location within a building based on access point signal strength, a GPS module capable of obtaining a geolocation from a GPS system, or other type of module or combination of modules.

Device servers 130 can be further configured to retrieve information from medical devices 110. In some embodiments, upon power up device servers 130 can send a query to medical devices 110 to obtain medical device information. Alternatively, device servers 130 can detect a corresponding medical device 110 to which they are connected. Example information that can be retrieved from medical device 110 can include a manufacturer, a model, a version number, patient data, medical data, medical record data, or other information generated by medical devices 110.

One should appreciate device servers 130 can include additional features beyond that of embedded devices 120 or medical devices 110, especially in view that embedded devices 120 or medical devices 110 could comprise legacy devices lacking features that are compatible with medical facility network 115 or hospital information system 140. Of specific note are legacy devices lacking proper authentication, authorization, encryption, or other security features that might be required by hospital information system 140. In such embodiments, devices servers 130 can include such features. Consider a scenario where hospital information system 140 requires secure transfer of patient data over a wireless network, possibly due to compliance under HIPAA. Device servers 130 can comply with such requirements through including compliance modules. Example integrated modules could include encryption-decryption modules (e.g., AES, DES, etc.), security protocol modules (e.g., SSL, SSH, etc.), authentication modules (e.g, Kerberos, RADIUS, HIP, etc.), authorization modules, firewall modules, inventory modules, location determination modules (e.g., GPS, geolocation, etc.), intrusion detection modules, inventory monitoring modules, audit control modules, or other modules. Thus, one should appreciate that device servers 130, or other servers in system 100, can provide include encryption, authentication, or other security services for medical devices 110 even if such legacy devices lack such capabilities.

Once device servers 130 obtain the retrieved information, device servers 130 can package the information into a desirable format, if necessary, and communicate the information to hospital information system 140 via medical facility network 115. For example, device servers 130 can convert the retrieved information from a medical device format to a desirable format acceptable by hospital information system 140 via a conversion module. In some embodiments, the medical device information is serialized into an XML format, JSON format, or other format. In other embodiments, device servers 130 can be configured to package the medical device information into an electronic medical record format; HL7 for example. Still further, device servers 130 can be configured to comply with health care standards; HIPAA, CCHIT, ANSI X12, DICOM, or other standards.

An example of a device server 130 that can be suitably adapted with the inventive subject matter includes the Lantronix EDS-MD. The EDS-MD can include 4, 8 or 16 individually isolated RS-232 serial ports with a Gigabit (10/100/1000 Mpbs) network interface. Going above and beyond the IEC-60601 requirement, EDS-MD provides galvanic isolation on all ports to ensure safety. If a grounding problem occurs, the operation of EDS-MD or other connected devices will not be affected. Set up and configuration of EDS-MD can be achieved via at least one of a web interface (i.e., HTTP), a command line interface (e.g., Telnet, SSH, etc.), XML interface, a remote procedure call, or other interface.

Further, the EDS-MD can be combined with a secure com port redirector as described in co-owned U.S. Pat. No. 7,660,910 to Miller titled “Secure Communication Port Redirector”, filed Aug. 30, 2004. Such a secure com port redirector provides virtualization software where existing serial port applications can work with EDS-MD without any code modifications. Virtual COM ports can be mapped to EDS-MD and encrypted at both ends of the communication, allowing the transport of sensitive information to and from remote device servers over the Internet with a high level of security (e.g., SSL, SSH, AES, etc.).

One should appreciate that device servers 130 are computing devices with processors and non-transitory computer readable memories capable of storing software instructions. Administrator 150 can download new instruction modules at any time to configure device servers 130 to operate in a manner compatible with medical devices 110. Thus, device servers 130 can be considered customizable or field configurable even after deployment.

In the example shown in FIG. 1, device servers 130 can communicate with hospital information system 140 over medical facility network 115, which could operate as a local network facility-wide network. It is also contemplated that device servers 130 can communicate with hospital information system 140 via Internet 125 in embodiments where hospital information system 140 is remote relative to the medical devices 110.

Hospital information system 140 is illustrated as database or server. One should appreciate that hospital information system 140 also has a number of roles or responsibilities within system 100 and with respect to medical devices 110. One responsibility of hospital information system 140 includes coordinating or managing activities of medical devices 110. Hospital information system 140, operating as a server for example, can be configured to send an initialization signal to one or more medical devices 110 through medical facility network 115 or through Internet 125. In response to medical devices 110 receiving the initialization signal (e.g., after receiving an ACK from the devices), hospital information system 140 can automatically initialize medical devices.

Although FIG. 1 illustrates hospital information system 140 operating as a server capable of initializing medical devices 110, one should appreciate that device servers 130 can also operate as a server. In embodiments where medical devices 110 lack an ability to properly integrate with hospital information system 140, devices servers 130 can be configured within one or more initialization modules, possibly provisioned from hospital information system 140, where the initialization modules instruct device servers 130 how to initialize corresponding medical devices 110.

Consider a scenario where medical device 120A is newly installed or deployed within system 100. Hospital information system 140 can automatically detect medical device 110A once medical device 110A is coupled with medical facility network 115. In some embodiments, medical device 120A can send a broadcast message or other type of discovery message over medical facility network 115, which can be detected by hospital information system 140. One should appreciate that hospital information system 140, or other server, can be configured to listen for one or more types of discovery messages. Depending on which transport layer port, format of the message, content of the message or other message attributes, hospital information system 140 can consult a look-up table to determine the nature of medical device 120A. In response, hospital information system 140 can obtain device initialization data (e.g., room number, hospital information, location, firmware updates if any, etc.) and submit the initialization data to medical device 120A.

In some embodiments, medical devices 110 can comprises multiple or duplicate devices. In such cases, hospital information system 140 can be configured to transmit an identity information request signal to the medical devices 110 over medical facility network 115. Such a request signal can be addressed to each specific medical device 110 or could be broadcast to all medical devices 110 depending on the requirements of the medical devices 110, or attached device servers 130. Medical devices 110 can then respond with their specific identify (e.g., GUID, UUID, serial number, patient ID, room number, location, etc.).

Hospital information system 140, or other server, can cause medical devices 110 to initialize through various techniques. In some embodiments, medical devices 110 can be initialized via placing medical devices 110 into an active power state. One should appreciate that initialization of medical devices 110 can include changing other types of state of the devices, possibly via device servers 130 or embedded devices 120. Example states can include a power state, a hibernation state, a data acquisition state, an activity state, a firmware update state, a connected state, or other state. Further, hospital information system 140 can further cause one or more software-based programs to be invoked. The programs can include scripts, compiled code, internal modules, or other instructions stored in the memory of the medical device 110.

Some embodiments employ a system or method to provide connectivity functionality to legacy and non-integrated medical devices in a health care setting. These embodiments can utilize graphical tools which are configured to facilitate interfaces with medical devices on embedded platforms. It is contemplated that a module having at least a monitoring function of interconnected medical devices that may be monitored by an administrator be provided. The module may also provide the administrator with the ability to communicate with the medical device and inventory assessments of medical devices sub-systems, components, or assets and may log medical data or events generated by the device. Some embodiments may further locate legacy and non-integrated medical devices which may be preferably connected to a hospital network and may notify an administrator of any potential problems with the medical device. The system may alert the health care facility of incoming medical information received by the medical device and may identify newly acquired devices.

Further, some embodiments employ a system or method to allow for remote monitoring and access to medical devices. The embodiments can utilize a device server which may remotely monitor medical devices and report information from the medical devices to an administrator or privileged user accessing the information received from the medical device at a remote location. It is contemplated that the system may also remotely monitor and diagnose potential problems or errors with the medical devices at remote locations from the device. In an exemplary embodiment, the system utilizes a device server. It is contemplated that at least first Distributed Services Controller (DSC) may have a conduit manager to create a first outgoing TCP/IP stream connection associated with a first virtual IP address to a Device Service Manager (DSM), which in turn relays communication traffic from the first outgoing TCP/IP stream connection to a second DSC. The second DSC also has a conduit manager to create a second direct outgoing TCP/IP stream connection associated with a second virtual IP address to the DSM. The first DSC resides in a first local network. The second DSC resides in a second local network distinct from the first local network. Suitable techniques that can be adapted for use with such embodiments are disclosed in co-owned patent application Ser. Nos. 12/306,042 (U.S. patent application publication 2010/0235481), 12/306,069 (U.S. patent application publication 2012/0284374), 12/306,145, and 13/080,566 (U.S. patent application publication 2011/0246630).

Other embodiments employ a system or method to gather, analyze and evaluate information from medical devices connected to a health care network. The present embodiments utilizes embedded device server to transmit information from the medical device to a hospital information system for further evaluation, or action when required. A module or embedded device may be associated with any specific medical device such that communication between the device and the hospital system may take place whereby information may be received by the hospital information system to evaluate medical device functionality and other important characteristics as desired by the administrator.

In an exemplary embodiment, it is contemplated that the system communicates with the medical device using a serial interface. However, it should be understood that any interface may be utilized including wireless, Ethernet, optical, PCI, or the like.

In yet another exemplary embodiment, a plurality of graphical tools to facilitate interfaces between a health care administrator and medical devices is contemplated.

Still another exemplary embodiment is to provide a system or method to communicate with medical devices and whereby at least an embedded device allows for communication between a medical device and a system administrator. In some embodiments, the embedded device converts medical data from the medical device into a standard medical format of ingestion by the medical facility data systems.

Yet another exemplary embodiment includes systems or method to interface between a plurality of medical devices and a medical facility network whereby an embedded device may be provided which allows for network connectivity between the medical device and the medical network.

In yet another exemplary embodiment, a system or method allow for interfacing between a plurality of medical devices and medical data engines whereby the system detects and locates a medical device in the medical treatment area by the medical facility network, and transmits an initialization signal from the medical facility network to the medical device.

Yet another exemplary embodiment provides a system or method to interface with medical devices whereby the system may initialize a medical device within a medical treatment area.

Still another exemplary embodiment is to provide a system or method to interface with a plurality of medical devices whereby the system may transmit medical device information in the medical treatment facility to a medical facility network or medical data engine (e.g., insurance database, EMR database, medical data analysis application, etc.).

Further, an exemplary embodiment includes a system or method to interface with a plurality of medical devices that allows for transmitting an initialization signal from the medical facility network to the medical device with an embedded device and automatically initializing the medical device in response to the medical device receiving the initialization signal.

In still another exemplary embodiment, a system or method are used to interface with a medical device whereby the system may have a terminal interfacing with the medical facility network, a display in communication with the terminal, and a medical device within range of the medical facility network. The medical facility network transmits an initialization signal to the medical device and the medical device is automatically initialized in response to receiving the initialization signal whereby the medical device may communicate with the medical facility network.

It is contemplated that the system or method to interface with a medical device comprises wireless communication capability, enabling the medical device to be automatically detected upon introduction into a medical treatment area and initialized in response to receiving an initialization signal from within the medical treatment facility over a wireless connection.

In yet another exemplary embodiment, a system or method to interface with a medical device can include wireless communication capability, enabling the medical facility network to transmit an initialization signal to one or more medical devices located within wireless range of the medical facility network.

From another perspective, it can be said that embodiments of the inventive subject matter remotely manage a medical device through an environment interface, using methods that can involve providing an add-on module that passes queries to the device and receives responses to the queries, at least in part through a serial interface.

In an exemplary embodiment, it is contemplated that a system is provided whereby the system may allow a plurality of devices to be monitored or information mined for analysis and review by an administrator.

An exemplary embodiment includes a system for collecting information from medical devices into a medical network, the system comprising: a medical device located within a health treatment facility whereby the medical device is connected to a medical facility network; an embedded device incorporated into the medical device; and a communication module which sends information from the medical device through the medical facility network and to a hospital information system.

In some embodiments, the embedded device communicates with a device server. In such embodiments it is contemplated that the embedded device can exchange data with the device server via a wired (e.g., serial, Ethernet, PCI, etc.) or wireless connection (e.g., 802.11, Bluetooth, etc.). Further, contemplated ecosystems can include many embedded devices coupled with medical devices, where the medical devices are substantially in continuous communication with the medical computing facilities, possibly over one or more networks (e.g., LAN, WAN, VPN, Internet, Intranet, etc.).

Preferably the embedded devices for communication between a medical device and a system administrator.

In yet another exemplary embodiment, it is contemplated that the system communicates with the medical device using a serial interface. However, it should be understood that any interface may be utilized including wireless, Ethernet and the like.

In yet another exemplary embodiment, a system or method for mining information from a medical device is provided whereby the system utilizes a device server.

Still another exemplary embodiment includes a system or method to communicate and receive information from medical devices whereby at least an embedded device allows for communication between a medical device and a system administrator.

In an exemplary embodiment, a system or method allows for mining of information from a plurality of medical devices whereby the system allows for integrating a medical device into a medical facility network whereby an embedded device may be provided which allows for network connectivity between the medical device and the medical network and whereby the embedded device may provide communication from the medical device to the medical facility network.

In yet another exemplary embodiment, a system or method collect information from a plurality of medical devices whereby the system allows for connection of an embedded device which allow for transmission of information from the medical device to the medical facility network and a hospital information system.

Yet another exemplary embodiment provides a system or method to collect information from a medical device whereby the system may allow for connectivity of legacy medical devices in a medical treatment area.

Still another exemplary embodiment provides a system or method to collect information from a plurality of medical devices whereby the system may transmit medical device information in the medical treatment facility to a medical facility network.

Further, an exemplary embodiment, a system or method includes collecting information from a plurality of medical devices whereby the system allows for transmitting medical device data, information and diagnostic information to a medical facility network by utilizing an embedded device.

In still another exemplary embodiment, a system or method collect information from a medical device whereby the system may have terminal interfacing with the medical facility network, a display in communication with the terminal, and a medical device within range of the medical facility network. The medical facility network transmits a signal to the embedded device server contained within the medical device for a response to the transmitted signal.

It is contemplated that the system or method collects information from a medical device whereby the medical device comprises wireless communication capability, enabling the medical device to communicate with a medical treatment facility hospital information system.

In yet another exemplary embodiment, a system or method collect information from a medical device whereby a medical facility network may have wireless communication capability, enabling the medical facility network to transmit a request signal to one or more medical devices located within wireless range of the medical facility network and to receive information from the medical devices.

From another perspective, it can be said that embodiments of the inventive subject matter allow for remote collection of information from a medical device through the use of an embedded device server, using methods that may involve providing an add-on module that passes queries to the medical device and receives responses to the queries, at least in part through a serial interface, wireless connectivity and the like. Additionally, it should be understood that the inventive subject matter may allow for manipulating data within the responses in a manner that provides at least a communication with a medical device which would not normally communicate with the health care facility network. Example technologies that can be suitably adapted for use include co-owned U.S. Pat. No. 7,698,405; U.S. Pat. No. 8,024,446; and U.S. Pat. No. 8,219,661.

In an exemplary embodiment, contemplated system relate to remote monitoring and diagnosis of medical devices.

Still another exemplary embodiment allows for remote monitoring and diagnostics of remote medical devices located on a medical network once the medical device has been located and incorporated into the medical network.

Still another exemplary embodiment provides for a system or method for remote monitoring and diagnosis of medical devices in a health care facility whereby the system may remotely monitor and diagnosis medical devices from within the health care facility or from outside the health care facility.

In an exemplary embodiment, a system or method for remote monitoring and diagnosis of medical devices is provided whereby the system may communicate with a medical device using at least one serial interface.

Yet another exemplary embodiment a system or method can remotely monitor and diagnosis medical devices, whereby the system may communicate with the plurality of medical devices by utilizing a wireless network, Ethernet, embedded device and the like.

In yet another exemplary embodiment, a system or method for remote monitoring and diagnosis of medical devices is provided whereby the system may monitor and diagnosis a plurality of medical devices associated with a health care facility where the medical devices are located on a heath care facility network.

Still another exemplary embodiment provides a system or method for remotely monitoring and diagnosing medical devices whereby the system utilizes a device server to communicate, monitor, and diagnose the current state of any medical devices connected or located by the system.

In an exemplary embodiment, a system or method for remotely monitoring and diagnosing a plurality of medical devices is provided, whereby the system allows for integrating and monitoring of any medical device, including any medical device that is newly added or changed within the medical facility.

In yet another exemplary embodiment, a system or method to remotely monitor and diagnose a medical device is provided whereby the system detects and locates a medical device in the medical treatment area by the medical facility network, initializes with the medical device and after initialization, remotely networks with the medical device such that an administrator may be able to monitor and review error messages from the medical device.

Yet another exemplary embodiment is to provide a system or method to remotely monitor and diagnose a medical device whereby the system detects and locates a medical device in the health care facility, initializes with the medical device and after initialization, may remotely network with the medical device such that an administrator may be able to monitor the device and be provided with data received periodically from the remotely located medical device.

Still another exemplary embodiment is to provide a system or method to remotely monitor and diagnose a medical device whereby the system may have a conduit manager to create a direct communication tunnel to a medical device.

Further, an exemplary embodiment can include a system or method to remotely monitor and diagnose a medical device whereby the system may have a first device server that resides in a first local network and the second device server that resides in a second local network distinct from the first local network.

It is contemplated that the system has a device server manager that resides in a wide area network (e.g., WAN) external to both the first and second device servers. Both the first and second device servers create their own direct communication tunnel to the device manager by periodically authenticating themselves to the device manager and establishing an outgoing TCP/IP stream connection to the device manager and then keeps that connection open for future bi-directional communication on the outgoing TCP/IP stream connection which allows for continual communication between the medical device and an initializing computer.

In still another exemplary embodiment, a system or method to remotely monitor and diagnose a medical device is provided whereby the system may allow a user or administrator located at a host console to open a connection to a designated port on a device server which establishes a connection through to the target medical device. The local device server will then initiate a connection to the controlling device manager which will manage the connection between the host and the medical device.

It is contemplated that the system or method to remotely monitor and diagnose a medical device can include allowing an administrator to receive incoming connection from the medical device whereby the communication may include both stream traffic (e.g. TCP/IP) and packet traffic (e.g. UDP) oriented network connections. The TCP packet header information in general identifies both the source port originally sending the data and the target destination port receiving the packet.

In yet another exemplary embodiment, a system or method for remotely monitoring and diagnosing a medical device is provided whereby the system may allow for targeting a remote medical device whereby the system may be notified when a targeted medical device is malfunctioning.

Still another exemplary embodiment is to provide a system or method for remotely monitoring and diagnosing a medical device whereby the system may load libraries to communicate with a medical device. The libraries can be obtained through a remote management system, a library database, through an API, or via a local removable storage device (e.g., drive, flash, etc.).

Yet another exemplary embodiment provides a system or method for remotely monitoring and diagnosing a medical device whereby the device server may be provided information from the medical device and transmit the data/information to a system administrator. The administrator may be able to view error messages, device data and other information for analysis, review and follow up actions.

Additionally, it should be understood that the inventive subject matter may allow for manipulating data within the responses in a manner that provides at least a communication with a medical device which would not normally communicate with the health care facility network.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for integration, collection and communication between a medical device and a hospital information system, the system comprising:
a medical device lacking an ability to connect to a medical facility network;
an embedded device incorporated into the medical device and configured to connect the medical device to the medical facility network; and
a device server coupled to the medical device and the medical facility network, and configured to:
locate the medical device;
retrieve information from the medical device; and
communicate the retrieved information to a hospital information system through the medical facility network.

2. The system of claim 1, wherein the embedded device communicates with the device server.

3. The system of claim 1, wherein a plurality of embedded devices in a plurality of medical devices are in continuous communication with the medical facility network.

4. The system of claim 1, wherein the medical facility network is coupled to the Internet.

5. The system of claim 1, wherein the medical facility network comprises a local network facility-wide network.

6. The system of claim 1 further comprising an embedded device incorporated into the medical device for communication between the medical device and a system administrator.

7. A system for integrating a plurality of medical devices into a medical facility network, the system comprising:
a medical device couple with a medical facility network; and
a server coupled with the medical facility network and configured to:
send an initialization signal to the medical device through the medical facility network; and
automatically initialize the medical device in response to the medical device receiving the initialization signal.

8. The system of claim 7, wherein the server is configured to automatically detect the medical device upon coupling to the medical facility network.

9. The system of claim 8, wherein after detection of the medical device, the server is configured to transmit an identity information request signal to the medical device through the medical facility network.

10. The system of claim 9, wherein in response to the identity information request signal, the medical device is configured to transmit an identity information signal to the server through the medical facility network.

11. The system of claim 7, wherein the server is further configured to initialize the medical device by powering the medical device into an active power state.

12. The system of claim 7, wherein the server is further configured to initialize the medical device by invoking a software program of the medical device.

13. The system of claim 7, wherein the medical facility network is coupled with the Internet.

14. The system of claim 7, wherein the medical facility network comprises a wireless network.

15. The system of claim 7, wherein the medical facility network comprises a local network or facility-wide network.
